(19) United States
(12) Patent Application Publication
(10) Pub. No.: US 2009/0231289 A1
(43) Pub. Date: Sep. 17, 2009

(54) PORTABLE PERSONAL COMPUTER AND CONTROL METHOD FOR THE SAME

(75) Inventor: LI-YING CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/116,210

(22) Filed: May 7, 2008

(30) Foreign Application Priority Data
Mar. 13, 2008 (CN) 200810300557.1

(51) Int. Cl. G06F 3/041; G09G 3/00

(52) U.S. Cl. 345/173; 345/1.3

(57) ABSTRACT

The invention relates to a portable personal computer that includes a first display, a second display, and an interconnection portion and a method for controlling the displays. The interconnection portion rotationally connects the first display to the second display. The portable personal computer generates corresponding sensor signals according to user-specific operation instructions, the first and second displays cooperatively display a joint image or separately display images according to the sensor signals and current display modes of the first and second displays.

### BACKGROUND

1. Field of the Invention

The present invention generally relates to personal computers and control methods for the personal computers.

2. Description of Related Art

Some portable computers, such as notebook and laptop computers, have small bodies to be conveniently carried and used anywhere. Other portable computers, such as personal digital assistants (PDAs) have rather smaller bodies that are even more convenient to move around. However, these smaller computers lack certain functions that can be accomplished by notebook and laptop computers.

Ultra mobile personal computer (UMPC) typically have a 7-inch screen and a body smaller than notebook and laptop computers, while slightly larger than that of PDAs. On the other hand, hardware of the UMPC is similar to that of notebook and laptop computers. Therefore, the UMPC is capable of many functions found in notebook and laptop computers, while still maintaining the convenience and portability of PDAs. However, a typical UMPC has a rather large keyboard, which is one of its main disadvantages.

### SUMMARY

In one embodiment, a portable personal computer is disclosed that includes a first display, a second display, and an interconnection portion. The interconnection portion rotationally connects the first display to the second display. The portable personal computer generates corresponding sensor signals according to user-specific operation instructions, the first and second displays cooperatively display a joint image or separate images according to the sensor signals and current display modes of the first and second displays.

Other advantages and novel features of the portable personal computer and control method will become more apparent from the following detailed description of embodiments when taken in conjunction with the accompanying drawings, in which:

### BRIEF DESCRIPTION OF THE DRAWINGS

FIG. 1 is an isometric view of a portable personal computer in accordance with an exemplary embodiment, the portable personal computer including a first display and a second display;

FIG. 2 is similar to FIG. 1, and shows an example of use;

FIG. 3 is a flow diagram of a control method for the portable personal computer of FIG. 2;

FIG. 4 is similar to FIG. 1, but viewed from another aspect and shows a second example of use; and

FIG. 5 is a flow diagram of a control method for the portable personal computer of FIG. 4.

### DETAILED DESCRIPTION

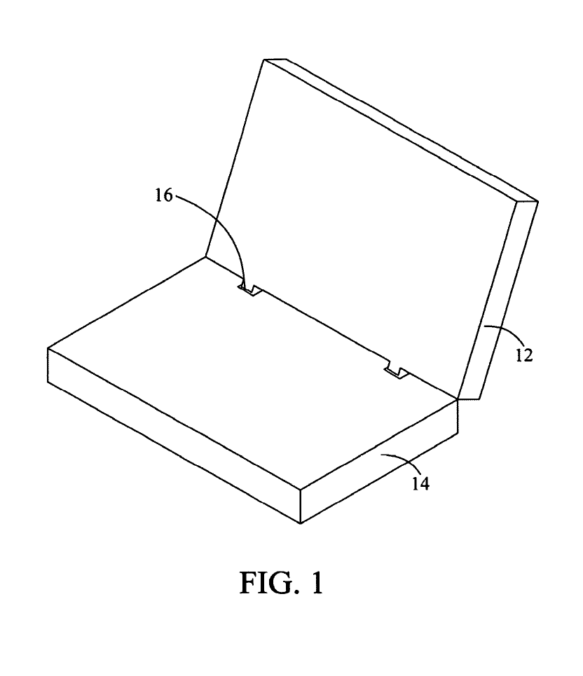

Referring to FIG. 1, a portable personal computer in accordance with an exemplary embodiment includes a first display 12, a second display 14, and an interconnection portion 16. The interconnection portion 16 rotationally connects the first display 12 and the second display 14. Therefore, the first display 12 can be folded with the second display 14 in order to save space.

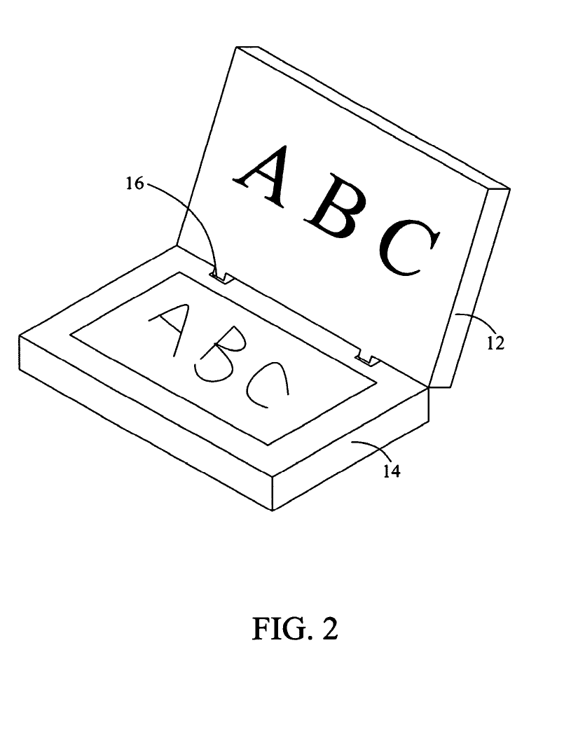

Referring to FIG. 2, the first and second displays 12, 14 are capable of generating separate displays. For example, the first display 12 can be used for displaying interfaces of operating systems and applications to users, while the second display 14 can be used for displaying a keyboard interface or providing a handwriting area for users to operate thereon. The second display 14 is capable of sensing operations and generating sensor signals accordingly. Therefore, the portable personal computer can be operated through the second display 14.

In other embodiments, the first display 12 is capable of sensing user operations and generate the corresponding sensor signals accordingly, or the first and second displays 12, 14 are both capable of sensing operations and generating corresponding sensor signals. The displays capable of sensing user operations may have sensors therein for generating the sensor signals according to the received user operations.

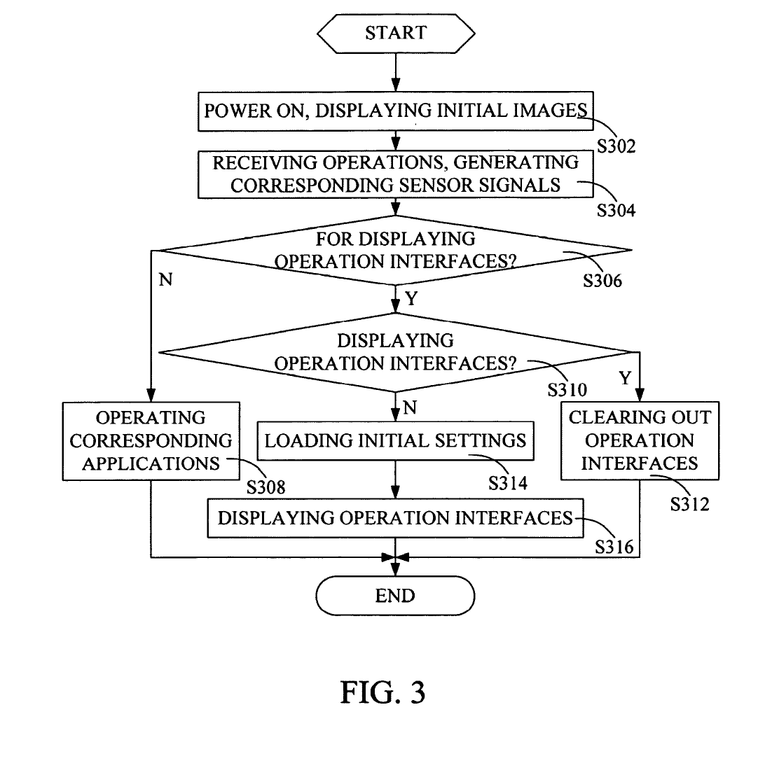

Referring to FIG. 3, a control method for controlling the portable personal computer of FIG. 2 in accordance with an exemplary embodiment includes the following steps:

Step S302, the portable personal computer is powered on and the operating system is loaded, the first and second displays 12 and 14 display initial images, respectively.

Step S304, the portable personal computer receives operation instructions from users, and generates corresponding sensor signals accordingly. The operations can be triggered by touching the first or second displays 12, 14, or pressing a particular key on the portable personal computer.

Step S306, the portable personal computer determines whether the sensor signals are used for controlling the operation interface to be displayed or cleared.

Step S308, if the sensor signals are not used for controlling the operation interface to be displayed or cleared, but used for other applications, the corresponding applications are operated.

Step S310, if the sensor signals are used for controlling the operation interface to be displayed or cleared, a current display mode of the first or second displays 12, 14 are detected.

Step S312, if the operation interface is currently displayed on the first or second displays 12, 14, the sensor signals trigger the displays to clear the operation interface from the first or second display 12 or 14.

Step S314, if there is no operation interface displayed on the first or second display 12 or 14, the first or second display 12 or 14 loads initial settings for displaying the operation interface and starting up sensors (not shown) for receiving the operation instructions.

Step S316, the first or second display 12 or 14 displays the operation interface, and starts up the sensors according to the initial settings that have been loaded. Therefore, users can operate on the displayed operation interface, and the first or second display 12 or 14 can generate corresponding sensor signals according to the operation instructions.

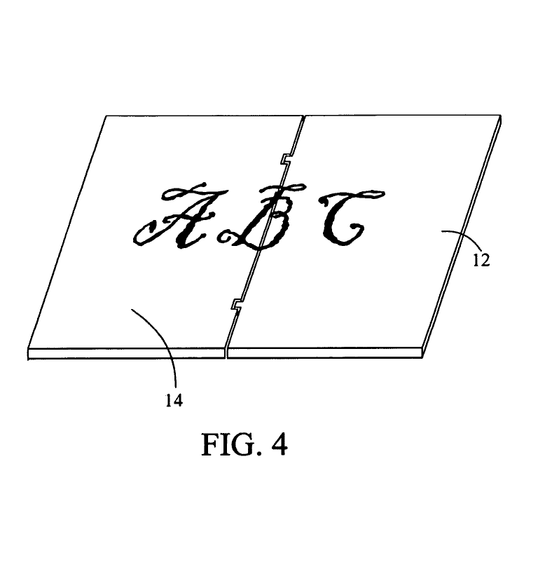

Referring to FIG. 4, the first and second displays 12 and 14 are capable of collaboratively displaying a single image. For example, when the portable computer displays a slideshow or video, the first and second displays 12, 14 can be used together as one display to cooperatively display a joint image. Therefore, a rather large visual area can be obtained.

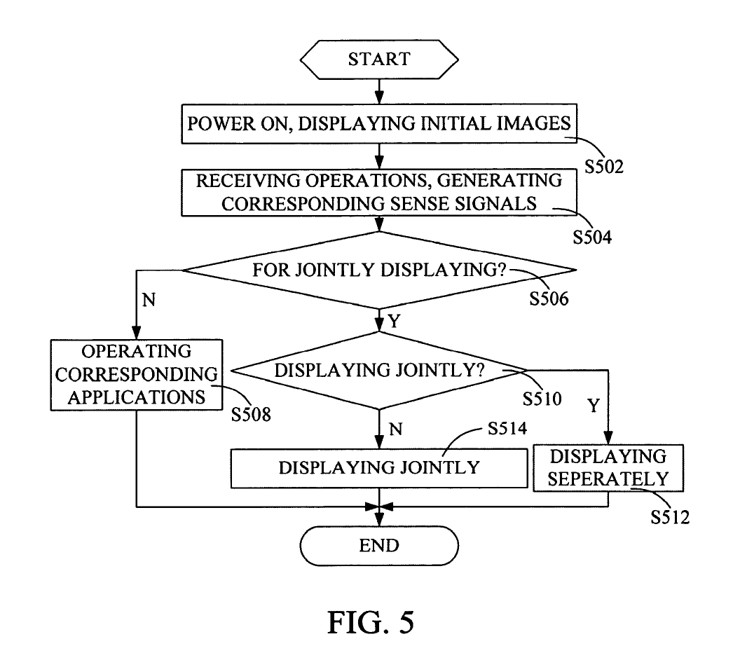

A control method for controlling the displays 12 and 14 of FIG. 4 includes the steps illustrated in FIG. 5:

Step S502, the portable personal computer is powered on and the operating system is loaded, the first and second displays 12 and 14 display initial images, respectively.

Step S504, the portable personal computer receives operation instructions from users, and generates sensor signals accordingly. The operations can be triggered by touching the first or second display 12, 14, or by pressing a particular key on the portable personal computer.

Step S506, the portable personal computer determines whether the sensor signals are used for controlling the displays 12 and 14 to cooperatively display a joint image or generate separate displays.

Step S508, if the sensor signals are not used for controlling the displays 12 and 14 to display cooperatively, but used for other applications, the corresponding application is operated.

Step S510, if the sensor signals are used for controlling the displays 12 and 14 to display cooperatively, current display modes of the first and second displays 12 and 14 are detected.

Step S512, if the first and second displays 12 and 14 are displaying cooperatively, the portable personal computer generates a control signal according to the sensor signal to trigger the first and second displays 12 and 14 to display different images.

Step S514, if the first and second displays 12 and 14 are displaying separately, the portable personal computer drives the displays 12 and 14 to display cooperatively.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A portable personal computer comprising:
a first display;
a second display;
an interconnection portion rotationally connects the first display to the second display; and
wherein the portable personal computer is configured to generate sensor signals according to user-specific operation instructions, the first and second displays capable of cooperatively displaying a joint image or separate images according to the sensor signals and current display modes of the first and second displays.

2. The portable personal computer as describe in claim 1, wherein at least one of the first and second displays is capable of receiving the user-specific operation instructions, and generating corresponding sensor signals accordingly.

3. The portable personal computer as described in claim 2, wherein the sensor signals are generated according to the operations on the display which is capable of receiving the user-specific operation instructions.

4. The portable personal computer as described in claim 1, wherein the sensor signals are generated by triggering a particular key.

5. The portable personal computer as described in claim 1, further comprising a controller configured to drive the first and second displays to display separately according to the sensor signals, if the current display modes show that the first and second displays are displaying cooperatively.

6. The portable personal computer as described in claim 1, further comprising a controller configured to drive the first and second displays to display cooperatively according to the sensor signals, if the current display modes show that the first and second displays are displaying separately.

7. The portable personal computer as described in claim 6, wherein in the display mode that the first and second displays are displaying separately, an operation interface is displayed on one of the first and second displays.

8. A control method for controlling a portable personal computer comprising:
providing a first display;
providing a second display;
receiving an operation instruction;
generating a corresponding sensor signal according to the operation;
detecting current display modes of the first and the second display; and
shifting the display mode of the first and the second displays according to the sensor signal and the current display modes.

9. The control method as described in claim 8, wherein at least one of the first and second displays receives the operation instruction, and generates the sensor signal accordingly.

10. The control method as described in claim 9, wherein the sensor signal is generated according to the operation on the display that receives the operation instruction; wherein input is capable of being received by a user via the display.

11. The control method as described in claim 8, wherein the sensor signal is generated by triggering a particular key.

12. The control method as described in claim 11, wherein the first and second displays are driven to display separately upon the condition that the current display modes show that the first and second displays are displaying cooperatively.

13. The control method as described in claim 11, wherein the first and second displays are driven to display cooperatively upon the condition that the current display modes show that the first and second displays are displaying separately.

14. The control method as described in claim 13, wherein an operation area is displayed on at least one of the first and second displays according to the sensor signal.
